(19) United States
(12) Patent Application Publication
(10) Pub. No.: US 2025/0162537 A1
(43) Pub. Date: May 22, 2025

(54) CONTROLLING AN ANTI-THEFT DEVICE

(71) Applicant: HARDCORE AUTOMOTIVE LOCKING TECHNOLOGIES (PTY) LTD, Mbombela (ZA)

(72) Inventor: Philippus Petrus Erasmus TALJAARD, Sonheuwel (ZA)

(21) Appl. No.: 18/947,060

(22) Filed: Nov. 14, 2024

(30) Foreign Application Priority Data
Nov. 16, 2023 (ZA) 2023/10628

(51) Int. Cl. B60R 25/01; B60R 25/20

(52) U.S. Cl. CPC B60R 25/01; B60R 25/20

(57) ABSTRACT

This invention relates to a vehicle anti-theft device and to methods of controlling such a device. The device includes an electronic control unit, an actuator, and a locking member which is movable between open and locked positions. The device further includes a dash or instrument panel mounted switch which is hard-wired to the ECU. In-cabin depression of the switch can overcome remote jamming and lock the device to prevent vehicle theft. The vehicle anti-theft device is further characterized in that operation of the switch cannot result in the unlocking of the locking member. Therefore, if unauthorised access to the vehicle cabin is gained, the switch cannot be used to unlock the device. The device also includes an auto-lock feature, upon vehicle turn off, and the switch can operate as a panic button if depressed for example 5 seconds.

### CROSS-REFERENCE TO RELATED APPLICATION

This application claims the benefit of South Africa Patent Application No. 2023/10628 filed on Nov. 16, 2023, the entire contents of which are incorporated herein by reference in its entirety.

### FIELD OF INVENTION

This invention relates to a vehicle anti-theft device and to methods of controlling the anti-theft device to counter vehicle theft and/or remote jamming.

### BACKGROUND OF INVENTION

Remote jamming is a practice employed by thieves to block or jam a legitimate signal, transmitted by a remote control of a vehicle owner, from being received by a receiver of a locking device of the vehicle. This is achieved when a thief simultaneously transmits a different signal, using a different remote, at the same frequency as the legitimate transmitter. This blocks the receiver of the locking device from receiving the lock signal from the legitimate remote. Consequently, having depressed the lock button on the remote, the owner may leave the vehicle under the false impression that it has been locked whilst being unaware of the fact that the signal was jammed. Once the owner has left the scene, the thief gains access to the unlocked vehicle.

The present invention aims to alleviate the drawback discussed above.

### SUMMARY OF INVENTION

According to a first aspect of the invention, there is provided a vehicle anti-theft device which includes:
an electronic control unit;
an anti-theft member which is configurable between an inactive condition and an active condition by the electronic control unit; and
a user input device which is communicatively wired to the electronic control unit of the vehicle anti-theft device, such that, when the user input device is operated, the anti-theft member of the vehicle anti-theft device is brought into its active condition in which it prevents theft of the vehicle, wherein the electronic control unit is characterized in that operation of the user input device cannot result in the anti-theft member being brought into its inactive condition.

The vehicle anti-theft device may include an actuator which is communicatively coupled to the electronic control unit and is drivingly connected to the anti-theft member to move the anti-theft member between a locked position in which it prevents theft of the vehicle and an unlocked position. The anti-theft member may take the form of a locking member. The user input device may be a switch. The switch may be a rocker-type switch and may include a light. The light may be a status light indicative of a status of the vehicle anti-theft device.

Upon the vehicle being turned off, the electronic control unit may be configured automatically to bring the anti-theft member into its active condition in which it prevents theft of the vehicle. Furthermore, upon the vehicle being turned off, the electronic control unit may be configured automatically to lock the anti-theft member.

The vehicle anti-theft device may include a wireless communication module which is communicatively coupled to the electronic control unit and is configured to communicate with a remote device. Upon predetermined lengthened operation of the user input device, the electronic control unit may be configured to forward a panic signal to the remote device via the wireless communication module.

In accordance with another aspect of the invention, there is provided a method of controlling the vehicle anti-theft device as described above, the method including:
receiving user input via the user input device; and
bringing, using the electronic control unit, the anti-theft member into its active condition.

The method may include:
receiving continuous user input via the user input device for a predetermined length of time; and
in response thereto, forwarding a panic signal to a remote device via a wireless communication module which is connected to the electronic control unit.

The method may further include:
detecting, using the electronic control unit, vehicle shut-off; and
in response thereto, automatically bringing the anti-theft member into its active condition using the electronic control unit.

In accordance with yet another aspect of the invention, there is provided a method of overcoming remote jamming of a vehicle locking device, the method including:
providing a user input device which is communicatively wired to the vehicle locking device; and
operating the user input device to lock the vehicle locking device, whilst not permitting unlocking of the vehicle locking device using the user input device.

The invention also extends to a vehicle which includes a vehicle anti-theft device as described above.

In accordance with yet another aspect of the invention, there is provided a method of controlling a vehicle anti-theft device which is configurable between a locked condition and an unlocked condition, the method including:
detecting, using an electronic control unit of the vehicle anti-theft device, vehicle shut-off; and
in response thereto, automatically bringing the vehicle anti-theft device into its locked condition.

### BRIEF DESCRIPTION OF DRAWINGS

The invention will now be further described, by way of example, with reference to the accompanying schematic drawings.

In the drawings:

FIG. 1 shows a functional block diagram of a vehicle anti-theft device in accordance with the invention; and

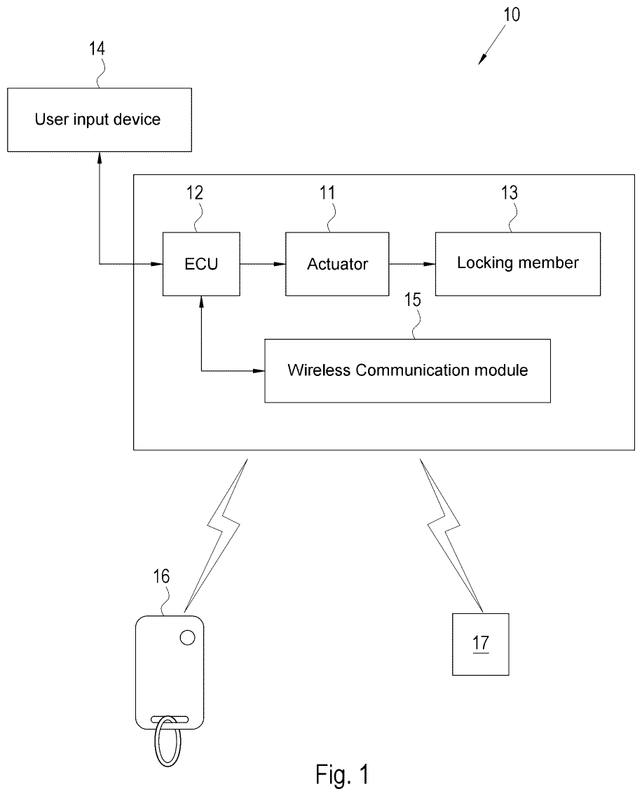

FIG. 2 shows a three-dimensional view of a switch for locking the vehicle anti-theft device mounted to an instrument panel of the vehicle.

### DETAILED DESCRIPTION OF AN EXAMPLE EMBODIMENT

The following description of the invention is provided as an enabling teaching of the invention. Those skilled in the relevant art will recognise that many changes can be made to the embodiments described, while still attaining the beneficial results of the present invention. It will also be apparent that some of the desired benefits of the present invention can be attained by selecting some of the features of the present invention without utilising other features. Accordingly, those skilled in the art will recognise that modifications and adaptations to the present invention are possible and can even be desirable in certain circumstances, and are a part of the present invention. Thus, the following description is provided as illustrative of the principles of the present invention and not a limitation thereof.

In the Figures, reference numeral 10 refers generally to a vehicle anti-theft device for preventing vehicle theft. The vehicle anti-theft device 10 is operatively installed to a vehicle (not shown) and includes an electronic control unit 12, an actuator 11, and an anti-theft member in the form of a locking member 13 which is configurable between an inactive or unlocked condition and an active or locked condition in which it prevents vehicle theft. The actuator 11 is coupled to the electronic control unit (ECU) 12 and is drivingly connected to the locking member 13 and is configured to move the locking member 13 between an open position and a locked position. The vehicle anti-theft device 10 is characterised in that it includes a user input device in the form of a dash or instrument panel mounted switch 14 which is communicatively wired to the electronic control unit 12 of the vehicle anti-theft device 10. The switch 14 is therefore hard-wired to the electronic control unit 12. The vehicle anti-theft device 10 further includes a wireless communication module 15 through use of which the vehicle anti-theft device 10 is configured to communicate with a remote device 17, e.g., one or more mobile phones and/or a remote security control room. The wireless communication module 15 is further configured to communicate with a conventional radio frequency remote control 16. As is commonplace, a user uses the remote control 16 as the primary means of locking/unlocking the locking member 13.

Alternatively, from within the vehicle cabin, the user may depress the switch 14 mounted to the instrument panel which causes the locking member 13 of the vehicle anti-theft device 10 to be moved into its locked position by the actuator 11. In its locked position, the locking member 13 prevents theft of the vehicle. The vehicle anti-theft device 10 is further characterized in that operation of the switch 14 cannot result in the unlocking of the locking member 13. Operation of the switch 14 can only lock the locking member 13. Therefore, if unauthorised access to the vehicle cabin is gained, the switch 14 cannot be used to unlock the vehicle anti-theft device 10.

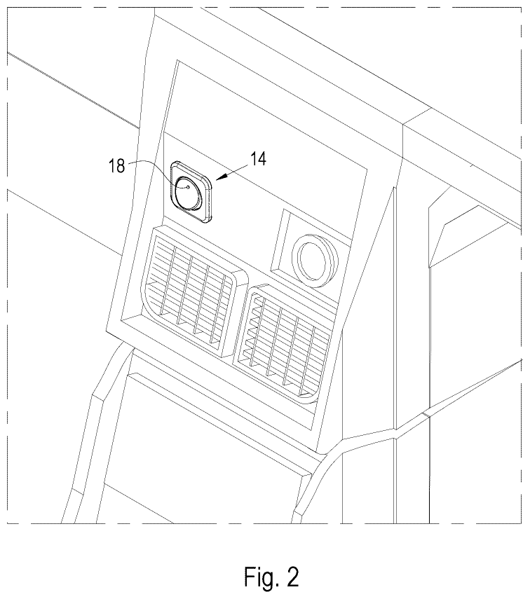

As can be seen in FIG. 2, in this example embodiment of the invention, the switch 14 is a rocker-type switch which includes a status indicating light 18. When the light 18 is lit up, it is indicative that the vehicle anti-theft device 10 is locked. Conversely, if the light 18 is off, the device 10 is unlocked.

The vehicle anti-theft device 10 is further characterised in that, as a default setting, upon the vehicle being turned off, the electronic control unit 12 is configured automatically to move the locking member into its locked position in which it prevents theft of the vehicle. The user may opt to turn this auto-lock functionality off by way of interacting with a purpose-built mobile phone application developed for the vehicle anti-theft device 10. The ECU 12 may therefore be coupled to the vehicle ignition.

In addition, if the user finds himself/herself in an emergency, the user can depress the panel-mounted switch 14 for a couple of seconds, e.g., 5 seconds, whereupon the electronic control unit 12 will forward a panic signal via the wireless communication module 15 to the security control room and/or one or more designated mobile phones. The panic signal includes a message indicating that the vehicle user is in distress and it also includes the vehicle's geolocation.

The vehicle anti-theft device 10 in accordance with the invention has the advantage that, should an attempt be made to jam the primary means of locking the vehicle anti-theft device 10, i.e., the radio frequency remote control, the user can make use of the switch 14 as an alternative, secondary means of locking the anti-theft device 10, despite the jamming incident. In this manner, the vehicle anti-theft device 10, more specifically, the panel-mounted switch 14, helps the user to overcome remote jamming whilst not permitting unlocking of the locking member in the absence of the radio frequency remote control.

Furthermore, the auto-lock feature, as an added benefit and default setting, helps prevent the vehicle anti-theft device 10 from remaining unlocked in the event that the user forgets to lock it after turning off their vehicle.

Finally, through extended depression of the switch 14, the vehicle anti-theft device 10 will automatically and silently forward a panic signal to one or more designated individuals and/or monitoring units, alerting them of distress and the vehicle's location. The convenient location of the switch 14 on the instrument panel means the switch 14 can be easily accessed in a barely noticeable manner and discretely depressed without making any sudden, significant hand movements which might startle a would-be hijacker. Despite that this has not been illustrated in the Figures, it will be appreciated that the switch 14 may be mounted on the driver-side instrument panel, which is disposed lower down when compared to the central panel, thus allowing more discrete access thereto.

1. A vehicle anti-theft device which includes:
an electronic control unit;
an anti-theft member which is configurable between an inactive condition and an active condition by the electronic control unit; and
a user input device which is communicatively wired to the electronic control unit of the vehicle anti-theft device, such that, when the user input device is operated, the anti-theft member of the vehicle anti-theft device is brought into its active condition in which it prevents theft of the vehicle, wherein the electronic control unit is characterized in that operation of the user input device cannot result in the anti-theft member being brought into its inactive condition.

2. The vehicle anti-theft device as claimed in claim 1, which includes an actuator which is communicatively coupled to the electronic control unit and is drivingly connected to the anti-theft member to move the anti-theft member between a locked position in which it prevents theft of the vehicle and an unlocked position.

3. The vehicle anti-theft device as claimed in claim 2, wherein the anti-theft member takes the form of a locking member.

4. The vehicle anti-theft device as claimed in claim 1, wherein the user input device is a switch.

5. The vehicle anti-theft device as claimed in claim 4, wherein the switch is a rocker-type switch which includes a light.

6. The vehicle anti-theft device as claimed in claim 1, wherein, upon the vehicle being turned off, the electronic control unit is configured automatically to bring the anti-theft member into its active condition in which it prevents theft of the vehicle.

7. The vehicle anti-theft device as claimed in claim 2, wherein, upon the vehicle being turned off, the electronic control unit is configured automatically to lock the anti-theft member.

8. The vehicle anti-theft device as claimed in claim 1, which includes a wireless communication module which is communicatively coupled to the electronic control unit and is configured to communicate with a remote device, wherein, upon predetermined lengthened operation of the user input device, the electronic control unit is configured to forward a panic signal to the remote device via the wireless communication module.

9. A method of controlling the vehicle anti-theft device as claimed in claim 1, the method including:
receiving user input via the user input device; and
bringing, using the electronic control unit, the anti-theft member into its active condition.

10. The method as claimed in claim 9, which includes:
receiving continuous user input via the user input device for a predetermined length of time; and
in response thereto, forwarding a panic signal to a remote device via a wireless communication module which is connected to the electronic control unit.

11. The method as claimed in claim 9, which includes:
detecting, using the electronic control unit, vehicle shut-off; and
in response thereto, automatically bringing the anti-theft member into its active condition using the electronic control unit.

12. A method of overcoming remote jamming of a vehicle locking device, the method including:
providing a user input device which is communicatively wired to the vehicle locking device; and
operating the user input device to lock the vehicle locking device, whilst not permitting unlocking of the vehicle locking device using the user input device.

13. A vehicle which includes a vehicle anti-theft device as claimed in claim 1.

14. A method of controlling a vehicle anti-theft device which is configurable between a locked condition and an unlocked condition, the method including:
detecting, using an electronic control unit of the vehicle anti-theft device, vehicle shut-off; and
in response thereto, automatically bringing the vehicle anti-theft device into its locked condition.
